(19) United States
(12) Patent Application Publication
(10) Pub. No.: US 2016/0164936 A1
(43) Pub. Date: Jun. 9, 2016

(54) PERSONAL AUDIO DELIVERY SYSTEM

(71) Applicant: STAGES PCS, LLC, Princeton, NJ (US)

(72) Inventor: Benjamin D. Benattar, Cranbury, NJ (US)

(73) Assignee: STAGES PCS, LLC, Ewing, NJ (US)

(21) Appl. No.: 14/960,157

(22) Filed: Dec. 4, 2015

Related U.S. Application Data
(63) Continuation-in-part of application No. 14/561,972, filed on Dec. 5, 2014.
Application No. 14/561,972 is a continuation-in-part of application No. 14/827,315, filed on Aug. 15, 2015.
Application No. 14/827,315 is a continuation-in-part of application No. 14/827,316, filed on Aug. 15, 2015.
Application No. 14/827,316 is a continuation-in-part of application No. 14/827,317, filed on Aug. 15, 2015.
Application No. 14/827,317 is a continuation-in-part of application No. 14/827,319, filed on Aug. 15, 2015.
Application No. 14/827,319 is a continuation-in-part of application No. 14/827,320, filed on Aug. 15, 2015.
Application No. 14/827,320 is a continuation-in-part of application No. 14/827,322, filed on Aug. 15, 2015.

(51) Int. Cl. H04L 29/06; G06F 17/30; H04L 29/08

(52) U.S. Cl. CPC H04L 65/4084; H04L 67/306; H04L 65/4015; H04L 67/04; H04L 63/102; G06F 17/30752

(57) ABSTRACT

The personal audio delivery system executed in part on a personal communication device to facilitate an enhanced audio experience for a user to select one or more audio streams to be delivered based on personal preferences and which may include related streams.

### CROSS REFERENCE TO RELATED APPLICATIONS

This application is a continuation-in-part of and claims priority and the benefit of the filing dates of co-pending U.S. patent application Ser. No. 14/561,972 filed Dec. 5, 2014, U.S. Pat. No. _______ and its continuation-in-part applications U.S. patent application Ser. No. 14/827,315 (Attorney Docket Number 111003); Ser. No. 14/827,316 (Attorney Docket Number 111004); Ser. No. 14/827,317 (Attorney Docket Number 111007); Ser. No. 14/827,319 (Attorney Docket Number 111008); Ser. No. 14/827,320 (Attorney Docket Number 111009); Ser. No. 14/827,322 (Attorney Docket Number 111010), filed on Aug. 15, 2015, all of which are hereby incorporated by reference as if fully set forth herein. This application is related to U.S. patent application No. ______ (Attorney Docket Number 111012); U.S. patent application No. ______ (Attorney Docket Number 111014); U.S. patent application No. ______ (Attorney Docket Number 111015); U.S. patent application No. ______ (Attorney Docket Number 111016); U.S. patent application No. ______ (Attorney Docket Number 111017); U.S. patent application No. ______ (Attorney Docket Number 111018); ______; U.S. patent application No. ______ (Attorney Docket Number 111019); and U.S. patent application No. ______ (Attorney Docket Number 111020), all filed on even date herewith, all of which are hereby incorporated by reference as if fully set forth herein.

### BACKGROUND OF THE INVENTION

1. Field of the Invention

The invention relates to a personal audio delivery system and more particularly a system for delivery of content related to a shared experience.

2. Description of the Related Technology

A silent disco involves party-goers dancing to music received wirelessly directly into headphones. Most commonly, the music is provided by one or sometimes two DJs who broadcast the music via an FM transmitter. Similar to the silent disco, the concept of mobile clubbing involves flash mob gatherings of people (sometimes in the hundreds) at public spaces at least portions of which are temporarily converted to clubbing areas in which people dance while listening to their personal music using MP3 players. Although both mobile clubbing and silent discos involve a gathering of people intent on having a good time, silent discos are typically held at a publicly advertised dance venue. Mobile clubbing on the other hand is more spontaneous in nature and likely to involve a location, such as a train station, not normally considered a dance venue. This spontaneity can provide an added surprise for the unwitting hosts of the space designated as the mobile club as well as members of the general public that happen to be in the general vicinity of the designated location. A festival concert is an event where the attendees may choose the musical experience they want by selecting among more than one performing act or other experience. In a festival concert setting it is difficult for attendees to obtain information concerning scheduling, live developments, and other supplemental information.

U.S. Pat. No. 8,521,316, the disclosure of which is expressly incorporated herein by reference, discloses a coordinated group musical experience whereby music listened to by each member of a group can be specifically selected by an individual member using a music characteristic such as tempo, common to all members.

However, none of discos, mobile clubs, or other coordinated group experience systems provide a mechanism for participant interaction and delivery of supplemental information.

Therefore, what is desired is a system and method for delivery of supplemental information and facilitating user interaction in connection with a multifaceted event.

### SUMMARY OF THE INVENTION

It is an advantage of the presently described embodiments to provide a shared music experience to a group of people. More particularly, the shared music experience can be specific to an individual group member but still share a common group music characteristic.

It is an object provide a personal audio delivery system. The system may be useful at a festival concert where a user wearing headphones can hear any source, stage, show, and designated information, directions, promotion, and other content anywhere. Content may be delivered over small-cell LTE stepped up or by another distribution methodology such as Wi-Fi, P2P, BLE, or cellular. The personal audio delivery system may be controlled using an app running on a personal communication device. Transmission media may be small-cell LTE stepped up and controlled by a mobile user interface on the personal communication device. In addition, the personal audio delivery system may facilitate coordinated group social discussion, speech and shared content experience (nightclub or festival or any environment such as a conference, convention, schoolyard, etc.). Speakers with accepted profiles may be included in a group audio chat utilizing a customized audio delivery system integrated with the personal audio delivery system.

The personal audio delivery system may be a networking content delivery system which includes a plurality of user profiles, each corresponding to a user ID. A connection table controlling the connections containing a plurality of authorization identifications may be provided with a connection authorization where the connection authorizations include one or more user IDs and corresponding content identifications. Matching logic responsive to user profiles and the connection table may be provided for establishing connections to one or more communication devices corresponding to one or more of the user IDS. The networking content delivery system may be controlled or coordinated through a connection server. The content identification may represent identification of stored content or streaming content. The streaming content may be live. The stored content may be live or messaging content. The content identification may identify a communications channel or an audio profile. The audio profile may be a directional or geographic profile or may be a profile characterizing audio information.

The system may generate notifications delivered to the personal communication devices identifying available content. The personal communication devices may include an interface to designate content that will be processed by the personal communication device. The system may include matching logic which represents a set of matching criteria that correlate one or more user IDs.

The system may implement a method of coordinating the delivery of audio content to a personal communication device which includes the steps of designating a principle content stream at the personal communication device, designating one or more supplemental context streams and customized content output of a personal communication device where the content output includes a principal audio content stream and at least one supplemental content stream.

It is an object to work with an audio customization system to enhance a user's audio environment. One type of enhancement would allow a user to wear headphones and specify what ambient audio and source audio will be transmitted to the headphones. Added enhancements may include the display of an image representing the location of one or more audio sources referenced to a user, an audio source, or other location and/or the ability to select one or more of the sources and to record audio in the direction of the selected source(s). The system may take advantage of an ability to identify the location of an acoustic source or a directionally discriminating acoustic sensor, track an acoustic source, isolate acoustic signals based on location, source and/or nature of the acoustic signal, and identify an acoustic source. In addition, ultrasound may be serve as an acoustic source and communication medium.

In order to provide an enhanced audio experience to the users a source location identification unit may use beamforming in cooperation with a directionally discriminating acoustic sensor to identify the location of an audio source. The location of a source may be accomplished in a wide-scanning mode to identify the vicinity or general direction of an audio source with respect to a directionally discriminating acoustic sensor and/or in a narrow scanning mode to pinpoint an acoustic source. A source location unit may cooperate with a location table that stores a wide location of an identified source and a “pinpoint” location. Because narrow location is computationally intensive, the scope of a narrow location scan can be limited to the vicinity of sources identified in a wide location scan. The source location unit may perform the wide source location scan and the narrow source location scan on different schedules. The narrow source location scan may be performed on a more frequent schedule so that audio emanating from pinpoint locations may be processed for further use.

The location table may be updated in order to reduce the processing required to accomplish the pinpoint scans. The location table may be adjusted by adding a location compensation dependent on changes in position and orientation of the directionally discriminating acoustic sensor. In order to adjust the locations for changes in position and orientation of the sensor array, a motion sensor, for example, an accelerometer, gyroscope, and/or manometer, may be rigidly linked to the directionally discriminating sensor, which may be implemented as a microphone array. Detected motion of the sensor may be used for motion compensation. In this way the narrow source location can update the relative location of sources based on motion of the sensor arrays. The location table may also be updated on the basis of trajectory. If over time an audio source presents from different locations based on motion of the audio source, the differences may be utilized to predict additional motion and the location table can be updated on the basis of predicted source location movement. The location table may track one or more audio sources.

The locations stored in the location table may be utilized by a beam-steering unit to focus the sensor array on the locations and to capture isolated audio from the specified location. The location table may be utilized to control the schedule of the beam steering unit on the basis of analysis of the audio from each of the tracked sources.

Audio obtained from each tracked source may undergo an identification process. An identification process is described in more detail in U.S. Patent Application No. 14/827,320 filed Aug. 15, 2015, the disclosure of which is incorporated herein by reference. The audio may be processed through a multi-channel and/or multi-domain process in order to characterize the audio and a rule set may be applied to the characteristics in order to ascertain treatment of audio from the particular source. Multi-channel and multi-domain processing can be computationally intensive. The result of the multi-channel/multi-domain processing that most closely fits a rule will indicate the processing. If the rule indicates that the source is of interest, the pinpoint location table may be updated and the scanning schedule may be set. Certain audio may justify higher frequency scanning and capture than other audio. For example speech or music of interest may be sampled at a higher frequency than an alarm or a siren of interest.

Computational resources may be conserved in some situations. Some audio information may be more easily characterized and identified than other audio information. For example, the aforementioned siren may be relatively uniform and easy to identify. A gross characterization process may be utilized in order to identify audio sources which do not require computationally intense processing of the multi-channel/multi-domain processing unit. If a gross characterization is performed a ruleset may be applied to the gross characterization in order to indicate whether audio from the source should be ignored, should be isolated based on the gross characterization alone, or should be subjected to the multi-channel/multi-domain computationally intense processing. The location table may be updated on the basis of the result of the gross characterization.

In this way the computationally intensive functions may be driven by a location table and the location table settings may operate to conserve computational resources required. The wide area source location may be used to add sources to the source location table at a relatively lower frequency than needed for user consumption of the audio. Successive processing iterations may update the location table to reduce the number of sources being tracked with a pinpoint scan, to predict the location of the sources to be tracked with a pinpoint scan to reduce the number of locations that are isolated by the beam-steering unit and reduce the processing required for the multi-channel/multi-domain analysis.

Other apparatuses, methods, features and advantages of the described embodiments will be or will become apparent to one with skill in the art upon examination of the following figures and detailed description. It is intended that all such additional systems, methods, features and advantages described within this paper be within the scope of and be protected by the accompanying claims.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

The described embodiments and the advantages thereof may best be understood by reference to the following description taken in conjunction with the accompanying drawings in which:

FIG. 1 shows a representative shared music session.

FIG. 2 shows an embodiment of a PCD during a shared music session.

FIG. 3 shows a content/connection selection subsystem.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. For the sake of clarity, D/A and ND conversions and specification of hardware or software driven processing may not be specified if it is well understood by those of ordinary skill in the art. The scope of the disclosures should be understood to include analog processing and/or digital processing and hardware and/or software driven components.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

According to an embodiment, the system facilitates delivery of supplemental information and communications amongst a group of people each using a personal communication device participating in a multifaceted event. In some cases the event may be spread across a large geographic area. In other cases participants may be densely assembled. In either case a single participant may not be able to observe all activities and participants in the multifaceted event. Examples of multifaceted events include, but are not limited to arena venues, festival events, fairs, and conventions/exhibitions. Information may be passed between personal communication devices of the participants using point-to-point wireless communication, a distributed network of computers such as the Internet, a wireless communication network, small cell LTE, Wi-Fi, and so on. In any case, information received at the personal communications devices can include an identification of the event and an indication of available content or identification of one or more other participants possibly according to some specified criteria that can be passed to a participant's personal communication device.

The system can be implemented as part of a communication system for establishing and providing preferred audio, as described in U.S. patent application Ser. No. 14/827,315, filed Aug. 15, 2015, the disclosure of which is expressly incorporated herein; and/or a mutual permission customized audio source connection system as described in U.S. patent application Ser. No. 14/827,316, filed Aug. 15, 2015, the disclosure of which is expressly incorporated herein.

In the described embodiments, the personal communication device can take the form of a portable media player along the lines of an iPod™ manufactured by Apple Inc. of Cupertino, Calif. The personal communication device can also take the form of a cellular phone such as an iPhone™ also manufactured by Apple Inc. or as a handheld computing device such as a tablet computer along the lines of an iPad™ also manufactured by Apple Inc. In any case, the personal communication device can be configured to wirelessly receive and in some cases may send a signal that can contain information that can include a menu of available content, requests for content and/or communication with or to facilitate communications with other participants and/or event updates or news flashes (announcements). The information can include a snippet or chunk of data that can be broadcasted by one or more devices to other devices that are within the transmission range of the broadcasting device(s). In one embodiment, the snippet or chunk of data can take the form of a token that can be used to seed a group of personal communication devices with the menu of available content. The token can be stored in a personal communication device and concurrently broadcasted to any other personal communication device using, for example, short message service (SMS) messaging or a Wi-Fi RF transmission. In this way, by broadcasting the information, each personal communication device can be made aware of the available content, event updates, and announcements at about the same time.

If broadcasting the information is not feasible (or deemed inappropriate), an ad hoc peer to peer (P2P) network can be formed using those personal communication devices capable of acting as a node. In this way, a first one of the personal communication devices can be used to seed the P2P network by, for example, wirelessly transmitting a signal that can include the token. For example, the first personal communication device can use a wireless protocol and wirelessly transmit a signal that can include the token, or its equivalent. Devices within the transmission range of the first personal communication device (Bluetooth is about 10 m, or 30 feet) capable of receiving and processing the signal can retrieve the token (or equivalent information) and in some cases store the token (or relevant portions) locally. In order to propagate the information within the P2P network, each device can, concurrently with the receiving of the signal, re-transmit the signal (including the token) to other personal communication devices within range of the sending device. In this way, each personal communication device properly configured for participation in the multifaceted event (and within range of at least another one of the participating personal communication devices) can share the same information including the available content, event updates, and announcements. In some implementations, in order to participate in the available content, event updates, and announcements, a communication application can be required that can provide the personal communication device with at least the appropriate network protocols required to exchange information with other personal communication devices in the P2P network. For example, various products manufactured by Apple Inc. (such as the iPhone™ and iPhone 3G™, iPod Touch™ iPad™) can participate in a P2P network using network protocols provided by the communication application.

In the described embodiments, the signal received at the personal communication device can include information other than the available content, event updates, and announcements. Such information can include any personal communication device identifiers, or PCDIDs, indicating the identity of those personal communication devices that have already received the information. In this way, a personal communication device can retrieve not only information related to the available content, event updates, and announcements, but other information related to those personal communication devices participating in the multifaceted event. One of the features of the PCDID is the ability to facilitate social networking within the group. In any case, the unique identifier (including any personalized information associated therewith) can be associated with the PCDID of the personal communication device and be passed between various other personal communication devices. In this way, a dynamic social network can be formed independent of or in conjunction with the available content, event updates, and announcements.

In addition to available content, event updates, and announcements, and any PCDIDs used to identity personal communication devices, the information (or the token for that matter) can include other information such as a time counter used to specify a start time and a stop time for a particular music session.

The menu of available content can be used to select audio content, event updates, and announcements stored or cached on each of the personal communication devices. The selection of available content, event updates, and announcements can be carried out in any number of different ways. For example, one of the ancillary services provided by the communication application can include categorizing content and/or stored on the personal communication device based upon various values of a particular music characteristic or content previously cached or individual identifications of participants. The communication application can create an alert to the presence of other participants selected on the basis of a specified criteria to facilitate ad hoc social networking connection. The criteria may be “fiends” or “contacts” within a certain distance. The criteria may also be based on common interests or other factors or information accessible to the system. The selected information may be prepared for private playing to a user of the personal communication device by way of a private listening accessory, such as headphones. In one embodiment, the music item(s) selected can be added to a playlist for private playing. The playlist can be presented for viewing on the personal communication device and in some cases, made available to the user for manual selection of specific content or connections. It should be noted that the individuals selected can be prequalified according to a specified criterion.

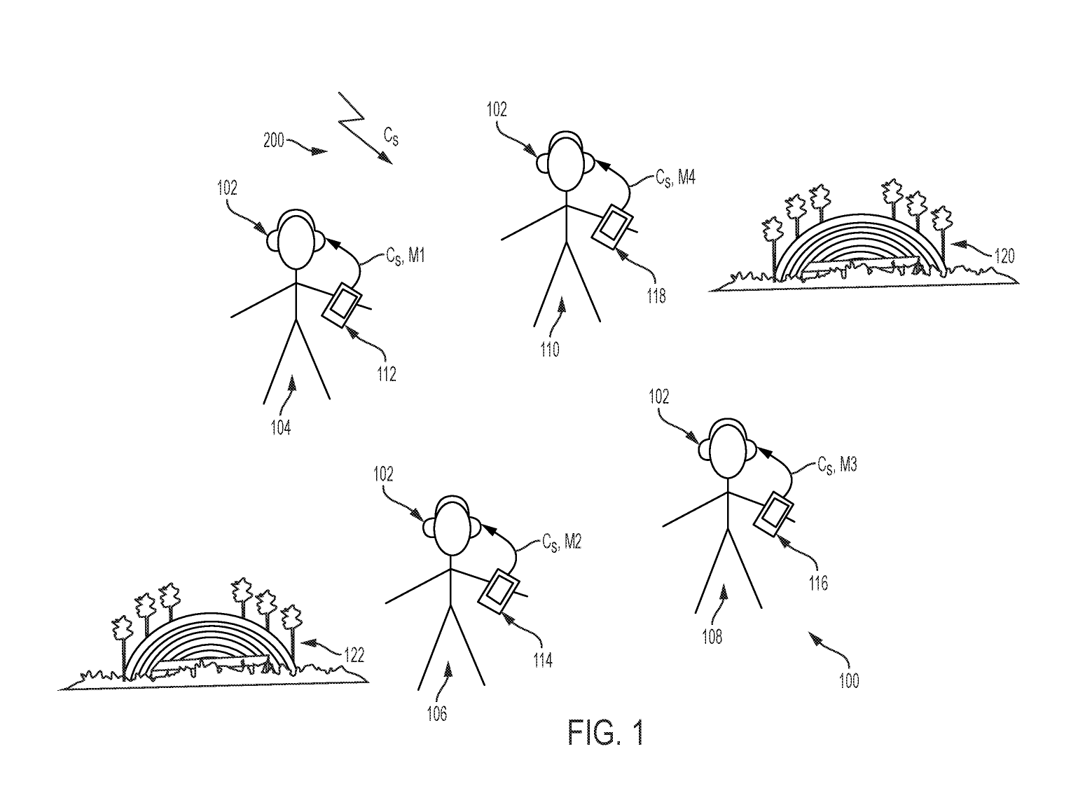

These and other embodiments are discussed below with reference to FIGS. 1-3. However, those skilled in the art will readily appreciate that the detailed description given herein with respect to these figures is for explanatory purposes only and should not be construed as limiting.

FIG. 1 shows group 100 participating in a multifaceted event. Along the lines of a music festival, group 100 can congregate at the event. The congregating can occur in separated areas, for example, at a first stage 120, a second stage 122, a food court exhibition area, etc. The participants can each be apprised of event updates by, for example, SMS messaging, emails (similar to a silent disco), instant messages, or a dedicated communication app such as the aforementioned audio communication or preferred audio systems. An event update might be an announcement that a particular act is about to perform at an identified stage. Each personal communication device (PCD) can privately play content for the associated member of group 100. The member can select the content it will receive. By privately playing it is meant that only the member in possession of the personal communication device can hear the privately played content. This audio privacy can be accomplished using private listening accessory 102 along the lines of a head phone, ear bud, and so on. The members may be listening to the same content broadcast, or listening to customized and/or selected content.

As shown in FIG. 1, members 104-110 of group 100 are each listening by way of private listening accessory 102 to content from items selected by each member from content stored on their respective portable media devices, content selected from a broadcast content requested from a server, and/or content customized for the member. In this way each member of group 100 can select content audio customization and networking communications relevant to the multifaceted event. For example, PCD 112 associated with member 104 can be privately playing content selected for play based upon content menu transmission Cs PCD 114 associated with member 106 can be privately playing content M2 also selected for play based upon content menu Cs. Although content M2 is selected for play based upon menu Cs, the personal preference or selection of member 106 determines the content M2 that is delivered or received.

In order to participate in the multifaceted event communications, each of PCD 114-PCD 118 must include communications infrastructure and a control interface to select and play appropriate content. In order to assure that each of the personal communication devices in group 100 has access to the content, a communication application (not shown) can be provided and stored on each of the personal communication devices. In one embodiment, the communication application can be part of an operating system provided upon the original purchase of a personal communication device. Alternatively, the communication application can be obtained after-market using, for example, remote media management services along the lines of iTunes. On the other hand, the communication application can be obtained in an ad hoc manner during, for example, an initial invitation session whereby part of an individual acceptance of an invitation to participate in the shared music session (using email, SMS messaging, Facebook, and so on) involves downloading and installing the communication application with a subsequent verification and acceptance.

In some cases, the system may communicate over an ad hoc P2P network, or by direct by broadcast 200 communications. It should be noted that broadcast 200 can take the form of a wireless RF transmission using any number and combination of available wireless protocols. For example, broadcast 200 can take the form of conventional over the air (OTA) AM or FM broadcast in which case the user can be instructed to manually input the appropriate tuning instruction to their respective personal communication device. Alternatively, broadcast 200 can take the form of a Wi-Fi or Bluetooth RF signal that the communication application can recognize as including the updated music characteristic information.

If the system utilizes an ad hoc P2P network a limited number of members of group 100 (referred to as initiators) can be identified to seed the P2P network with announcements or a menu of available content. For a more detailed description of the heuristics of distributing information in an ad hoc P2P network please refer to “On Disseminating Information Reliably Without Broadcasting”, Proc. 7th Int. Conf. on Distributed Computing Systems (ICDCS-7), pp. 74-81 Berlin, September 1987 by Alon, N., Barak, A. and Manber, U and “An Asynchronous Algorithm for Scattering Information Between the Active Nodes of a Multicomputer System”, Journal of Parallel and Distributed Computing, Vol. 3, No. 3, pp. 344-351, September 1986 by Drezner, Z. and Barak each incorporated by reference in their entireties. Assuming that member 106 has been designated as an initiator, member 106 can seed ad hoc P2P network 302 with the event information. Member 106 may be replaced by an initiation server acting as a control station.

It is foreseeable that due to local conditions, it may not be possible to reliably send information from one node directly to another node in P2P network. For example, PCD 114 belonging to member 106 (initiator) can broadcast token T that can be received by PCD 112 and PCD 116 belonging to members 104 and 108, respectively. However, member 110 may be too far away or may be in an area (such as behind a wall) where direct reception by PCD 118 is unlikely. Therefore, each node of network can be instructed to retransmit the information wirelessly upon receiving information wirelessly. For example, when PCD 116 (as well as PCD 112) wirelessly receives the event information each can generate re-broadcast a signal that includes the event information received from member 106. In this way, PCD 118 can receive re-broadcast content information from PCD 116 (as well as that from PCD 112).

In some cases, a multifaceted event can have session rules. The session rules can define various relationships and actions that can occur between the members of the group during a specific session. For example, the session rules can provide criteria for identifying networking proposals for individual members to connect during the session. In this way, by setting the session networking rules individual members can be identified to each other and establish social networking communications, for example, as described in U.S. patent application Ser. No. 14/827,315 filed Aug. 15, 2015, entitled “Communication system for establishing and providing preferred audio,” the disclosure of which is expressly incorporated by reference herein.

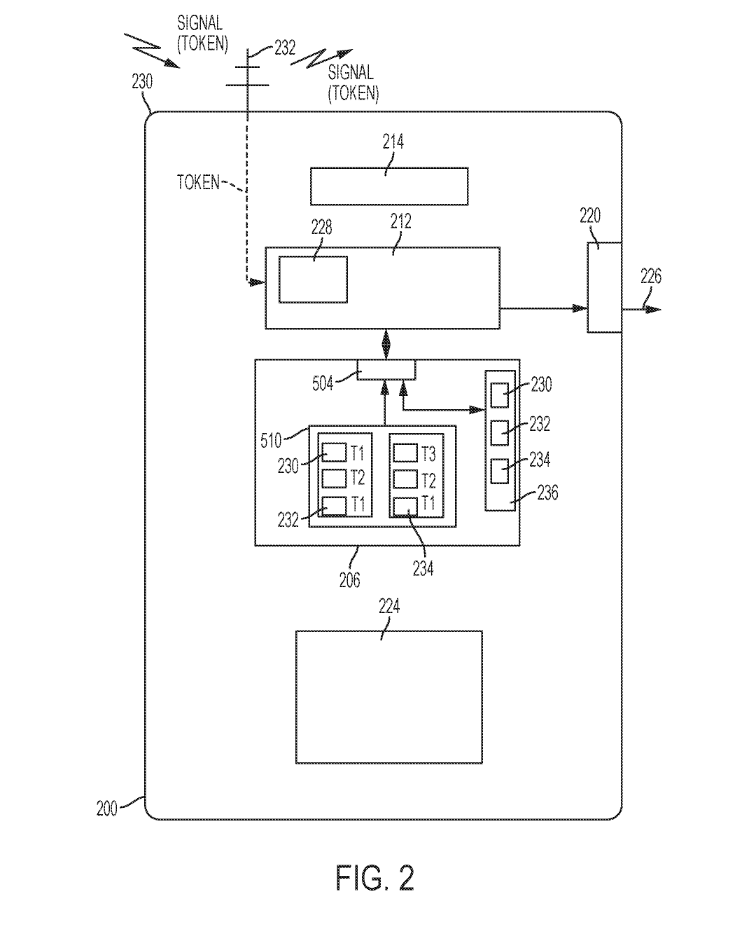

FIG. 2 shows a block diagram of a representative personal communication device (PCD) 200 in accordance with the described embodiments. PCD 200 can be formed to include at least housing 202 configured to enclose and support various operational circuits. In some cases, PCD 200 can include controller 504 used to control data storage device 206 that can be used for storing a plurality of data files that can take the form of, for example, audio data, textual data, graphical data, image data, video data and multimedia data. The stored data files can be encoded either before or after being stored using a variety of compression algorithms. It should be noted that a user can interact with manager 212 through an interface. For example, audio content can be compressed using MP3, AAC and Apple Lossless compression protocols. Other data may be compressed using protocols appropriate to such data. The audio content can include, for example, auxiliary content files 208 stored in memory 510 controlled by the content manager 212. Content manager 212 can be embodied as software executed by processor 214 or as a separate hardware component. In any case, content manager 212 can control the audio output of content files 208 stored in memory 510. The content may also include available content menus, in audio or graphic form as well as social networking criteria and/or identification.

During operation, for example, content manager 212 can select content item 216 from auxiliary content 208 which can be decoded using an appropriate codec. The decoded content file can then by output as audio signal 218 to audio output interface 220. In accordance with one embodiment, content manager 212 can select content items 216 identified by a user through a guide or by voice command. Furthermore content manager 212 may receive transmission of content and play such content substantially in real time, subject to loading, buffering and decoding delays and subject to any user control such as pause or rewind or replay.

Content may include a tag 222 to identify content type or other characteristic of the auxiliary content. For example, in a music festival the tag may indicate that the content is a commercial advertisement or offer. The tag may indicate information regarding purchase of the content, or may identify the facet of the multifaceted event that the content relates to. For example, the tag may indicate that the content relates to a performance on stage.

User input interface 224 can assist a user of PCD 200 in controlling various functions performed by PCD 200. For example, user interface 224 can include a touch sensitive layer (not shown) that can facilitate the use of a user touch event for inputting control instructions or the user interface may be an audio interface for voice commands. In the case where PCD 200 includes speakers, then audio signal 218 can be broadcast to the external environment via the speakers. However, in those situations where PCD 200 does not include speakers, or the speakers can be bypassed, PCD 200 can include private listening interface 226 suitable for directing audio signal 218 to an external transducer associated with a personal listening accessory, such as earphones, ear buds, and so on. The personal/listening device may also include a microphone for detecting and sensing audio. In this way, the user of PCD 200 can privately listen to audio output by music manager 212. PCD 200 can also include wireless interface 228 arranged to both receive and transmit information by way of any suitable wireless protocol such as, for example, Wi-Fi, Bluetooth, and so on capable of accessing various configurations of wireless networks, such as WLAN or peer to peer (P2P). It should be noted that even though only a limited set of components are shown this does not imply a limitation on the functional components that can be included in PCD 200. For example, in addition to the components shown in FIG. 5, embodiments of PCD 200 can also include a power connector, a data transfer component, voice recognition circuits, and so on.

Content manager 212 can customize the audio experience of the user. The audio may be processed to enhance and/or mask aspects of the audio to be delivered to the user, for example, in accordance with the techniques described in co-pending patent application Ser. Nos. 14/561,972 (111001), 14/827,315 (111003), 14/827,316 (111004), 14/827,320 (111009), and ______ (111018).

In another implementation, content manager 212 can control social networking functionality. Selective networking may be provided by identifying participants in the event that satisfy a selection criteria. The system may allow a user the option of establishing networking communications with other participants who satisfy the selection criteria and designated by one or both users.

A communication application 228 can provide instructions executable by processor 214 for controlling the operations of PCD 200. In the described embodiment, the communication application can be downloaded from an online data store automatically or as a result of a user selection at user interface 224 from a central media management application (such as iTunes™) or from Apps Store maintained by Apple Inc. Alternatively, communication application 228 can be present at the time of original purchase. In any case, communication application 228 maintains a connection table to be periodically updated. The updating can occur, for example, during a synchronization operation performed between PCD 200 and a central media management application (such as iTunes™). The updating can also occur on an ad hoc basis.

Communication application 228 can provide a mechanism by which a user of PCD 200 can participate in a social networking experience provided that a connection between two users satisfies a criteria identifying a suggested connection. In addition to providing services required for participation in the social networking experience, communication application 228 can provide PCD 200 with at least the appropriate network protocols required to exchange information with other personal communication devices in a P2P network. In addition to providing the requisite communication protocols, communication application 228 can provide services related to categorizing music items stored on PCD 200 based upon various values of a particular music characteristic. The selection and networking function can be based in or distributed among PCDs or be server based. In a server-based system, the server may be local (logically) to the multifaceted event or remote such as a server connected through a wide area network including, without limitation, the Internet.

In any case, PCD 200 can obtain a connection token T by way of RF transmission 230. It should be noted that if PCD 200 is a node in a P2P network, RF transmission 230 can originate from another personal communication device within the network. In this situation, upon receiving token T, PCD 200 can generate re-broadcast signal 232 that includes at least token T while storing only tokens designated for that user. In this way, other personal communication devices with the P2P network can receive connection tokens applicable to other devices. Tokens can be transmitted by way of RF transmission 230 that originates from a central broadcaster unit. It is also possible that PCD 200 does not have wireless capabilities, in which case the token T can be provided by the communication application 228. In this way, a more limited session can be held since only those personal communication devices that have the same version of communication application 228 can participate. For example, in order to participate, PCD 200 may require the latest version of token T which can be obtained during, for example, a synchronization operation performed between the personal communication device and a central media management application.

Once token T has been received, processor 214 can determine if token T has an indication of supplemental content. For example, token T can indicate availability of content which might be background information, coupon or commercial offers, or schedules. In this case, the user may have the option to listen to the supplemental content which may be requested or accessed and can be privately played by PCD 200. Accordingly content 230, 232, and 234 each tagged as an ID that corresponds to token t1 may be accessed. In the described embodiment, a content venue 236 can be visually displayed at interface 224.

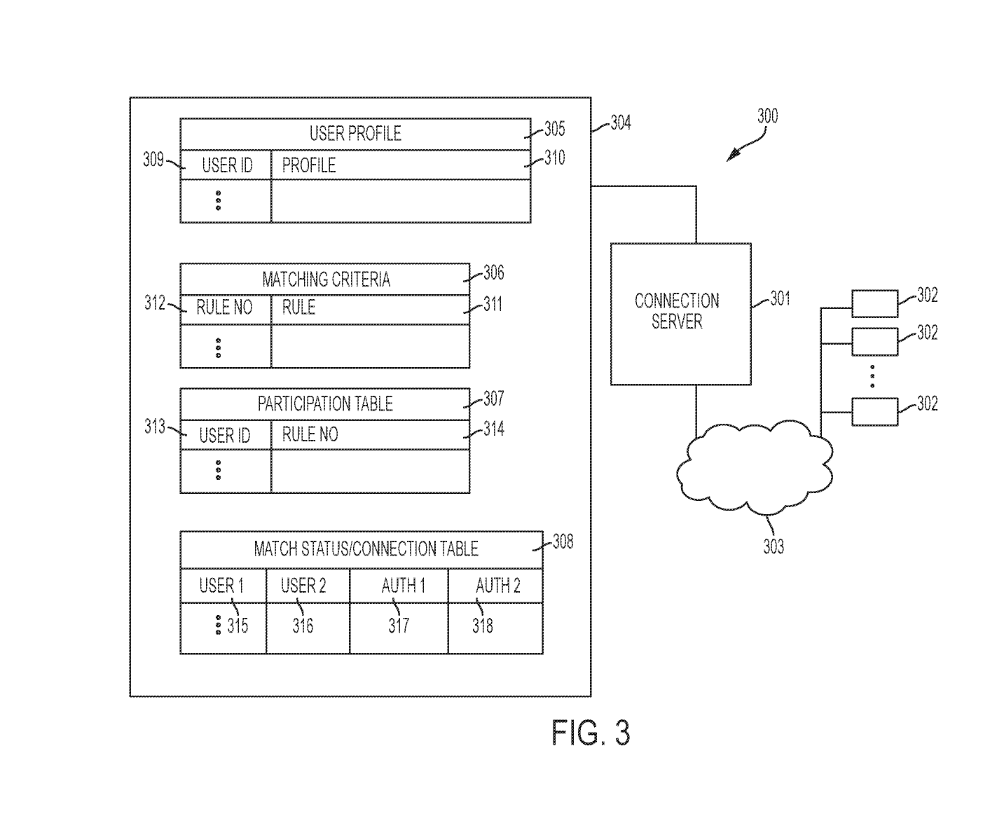

FIG. 3 shows an event-centric networking matching system 300. The system includes a connection server 301 connected to a plurality of user personal communication devices 302 by a network 303. The personal communication devices 302 may have an interface for users to control, provide instructions, and provide information to the system. Alternatively the instruction and information interface may be a separate terminal also connected to the network 303. The network 303 may be a wired or wireless local area network or wide area network. The connections may be by Bluetooth, peer-to-peer connections, small cell LTE or any other connection mechanism. The system is not specific to a particular network. The communication server 301 may be connected to data storer 304.

FIG. 3 illustrates a single data storer 304 in the form of a database management system however individual tables or distributed tables may be utilized. The data may be distributed among the users 302 or centrally located. The data may include user profile data 305 composed of a user ID 309 associated with a profile 310. The profile may include any information used by the system related to the user, for example, user name, password, gender, musical tastes, playlist, age, geographic location and any other demographic information. The system may also include a matching criteria table 306. The criteria table may include a plurality of rules 311, each associated with a rule number 312. In addition, the system may include a participation table 307 which includes a user ID 313 as an index and a rule number 314 correlating to rule numbers 312 of the matching criteria table 306. The participation table 307 includes a list of user IDs correlated to the rule numbers and the matching criteria table 306 includes those rule numbers correlated to matching criteria. Each user may be subscribed to one or more of the criteria as indicated by entries in the participation table 307. The matching criteria may include one or more requirements such as an identification of an event, a location service matching criteria, demographic matching criteria, a flag indicating appearance in a contact or approved list, and other criteria. In the example of a multi-faceted event such as a concert festival, the system may first identify all users who are participating in the event, i.e. are attending the music festival. This may be accomplished by determining which users have purchased tickets or have a token on their PCD indicating they have been admitted to the event. Alternatively, participation may be determined by location services. Each user may establish or subscribe to criteria which, if satisfied, suggests a connection. A matched status connection table 308 may be established in order to identify connections approved in accordance with the proper operation of the system. The system may go through each entry in participation table 307. For each entry the rule corresponding to the user ID may be utilized to evaluate all of the entries in the user profile table. When an entry in the user profile table satisfies a user ID rule designation, an entry may be placed in the matched status connection table 308 of the user ID in the user 1 field 315. The ID of the user who satisfied the criteria may be placed in user 2 field 316. The system may use different logic or sequences, but the idea is to create a table which has an entry for each pair of users who both satisfy the other's designated criteria. The designated criteria may be customized by each user and/or established by the system. An additional feature may permit each participant in a connection to approve or deny access even though the established criteria have been satisfied. Alternatively, one of the criteria may be approval of the matching user.

The system may also be able to establish communication groups so that connections may be one-to-many or even one-to-all. This may be established by user ID corresponding to a group criteria and each individual user who matches the group criteria is connected in the group. The system may impose an artificial limitation of allowing participation in only a single group.

According to a further feature, auxiliary content may be organized as a user. When a particular user requests a menu for auxiliary content and selects one or more items from the menu, that selection can be established as an approved connection criteria, but the connection may be to pre-recorded or live content rather than another PCD. Finally, the system may force certain connections so that the event organizers are able to provide certain communications either individually or as broadcast without separate authorization of the users.

The techniques, processes and apparatus described may be utilized to control operation of any device and conserve use of resources based on conditions detected or applicable to the device.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of a personal audio delivery system have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A networking content delivery system comprising;
a plurality of user profiles including a user ID;
a connection table containing a plurality of connection authorization wherein a connection authorization includes one or more user IDs and corresponding content identifications; and
matching logic responsive to said user profiles and said connection table for establishing connections to one or more communication devices corresponding to one or more of said user IDs.

2. A system according to claim 1 wherein said content identification compromises identification of stored content.

3. A system according to claim 1 wherein said content identification comprises identification of streaming content.

4. A system according to claim 3 wherein said identification of streaming content is identification of at least one audio stream of a plurality of audio streams.

5. A system according to claim 1 wherein said content identification comprises identification of one or more social networking connections.

6. A system according to claim 1 wherein said connection server generates notifications of authorized content corresponding to one or more user IDs.

7. A system according to claim 1 wherein said matching logic further comprises a set of matching criteria and a correlation between a matching criteria and one or more user IDs.

8. A method of coordinating delivery of audio content to a plurality of personal communication devices comprising the steps of:
designation of a principle audio content stream at one or more personal communication devices;
designation of one or more supplemental content streams at said one or more personal communication devices; and
customizing content output at a personal communication device wherein said content output includes a principle audio content stream and at least one supplemental content stream.

9. A method according to claim 8 wherein said principle audio content stream comprises stage specific content selected from a plurality of available stage specific content streams.

10. A method according to claim 9 wherein said designation of one or more supplemental content streams comprises designation of a content stream having an audio profile corresponding to a profile designated by a personal communications device.

11. A method according to claim 9 wherein said designation at one or more supplemental content streams comprises designation of a stream representing background information related to said principle audio content stream.

12. A method according to claim 9 wherein said designation at one or more supplemental content streams comprises designation of a stream representing background information related to scheduling information.

13. A method according to claim 9 wherein said designation at one or more supplemental content streams comprises designation of a stream representing background information related to a user ID that represents a user profile satisfying designated criteria.

14. A method according to claim 8 wherein said steps are executed to facilitate an enhanced audio experience at a festival concert whereby users select which act to listen to at a plurality of acts performing simultaneously and users select supplemental content which includes a schedule of performances, venue information, commercial offers, or social networking connections.
